(19) United States
(12) Patent Application Publication
(10) Pub. No.: US 2022/0309392 A1
(43) Pub. Date: Sep. 29, 2022

(54) RECOMMENDATION APPARATUS

(71) Applicant: DENSO TEN Limited, Kobe-shi (JP)

(72) Inventors: Masayuki TOYODA, Kobe-shi (JP); Hiroyuki WATABE, Kobe-shi (JP)

(73) Assignee: DENSO TEN Limited, Kobe-shi (JP)

(21) Appl. No.: 17/481,557

(22) Filed: Sep. 22, 2021

(30) Foreign Application Priority Data
Mar. 25, 2021 (JP) 2021-051910

(51) Int. Cl. G06N 20/00; G06N 7/00; G06F 16/9535

(52) U.S. Cl. CPC G06N 20/00; G06N 7/005; G06F 16/9535; G06F 3/0482

(57) ABSTRACT

A recommendation apparatus recommends content to a user. The apparatus includes: a memory that stores a probability distribution of a probability of a likelihood of matching a preference of the user; and a hardware processor. The probability distribution is across a plurality of content genres of the content. The hardware processor is programmed to: (i) select a content to be recommended to the user based on the probability distribution, (ii) update the probability distribution by learning from a feedback about acceptance or nonacceptance by the user of the content that was recommended, and (iii) obtain profile information of the user. The profile information of the user is reflected in an initial setting of the probability distribution.

### BACKGROUND OF THE INVENTION

### Field of the Invention

The invention relates to a technology that recommends a content to a user.

### Description of the Background Art

A type of recommendation apparatuses that recommend a content to a user uses machine learning, etc. to learn a preference of the user.

However, in a case of the recommendation apparatus that uses machine learning, etc. to learn the preference of the user, if the user does not use the recommendation apparatus, the preference of the user is not learned. Thus, there is a problem that the recommendation apparatus takes time to offer a content matching the preference of the user.

There are techniques, such as collaborative filtering, to estimate an individual preference. Such a technique to estimate the individual preference determines a similarity degree of a content based on choices of other people, an attribute of the content, etc. and then estimates a preference of a user based on the similarity degree of the content. Therefore, the technique does not learn the preference of the user itself. Thus, in a case where a recommendation is offered based on the estimated preference of the user, the recommendation may be totally different from the preference of the user. Moreover, since the similarity degree of the content is determined based on choices of other people, the attribute of the content, etc., huge database is required for valid estimation.

Moreover, bandit algorithm is an example of a method that facilitates learning. The bandit algorithm deliberately offers estimation results and receives feedbacks on those results to improve efficiency in learning. However, since the estimation results are evenly offered, in many cases, contents that are mismatched with the preference of the user are offered, which leads to dissatisfaction of the user.

### SUMMARY OF THE INVENTION

According to one aspect of the invention, a recommendation apparatus recommends content to a user. The apparatus includes: a memory that stores a probability distribution of a probability of a likelihood of matching a preference of the user; and a hardware processor. The probability distribution is across a plurality of content genres of the content. The hardware processor is programmed to: (i) select a content to be recommended to the user based on the probability distribution, (ii) update the probability distribution by learning from a feedback about acceptance or nonacceptance by the user of the content that was recommended, and (iii) obtain profile information of the user. The profile information of the user is reflected in an initial setting of the probability distribution.

An object of the invention is to provide a recommendation technology that improves satisfaction of a user.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 shows an example of a schematic configuration of a content offering system of this embodiment;

FIG. 2 shows an example of a probability distribution for a user who is male in his thirties;

FIG. 3 shows an example of a probability distribution for a user who is female in her twenties;

FIG. 4 shows a flowchart illustrating an initial operation of a recommendation apparatus;

FIG. 5 shows an example of a profile information input screen;

FIG. 6 shows an example of the profile information input screen when a user input is completed;

FIG. 7 shows another example of the profile information input screen when the user input is completed;

FIG. 8 shows a modified example of the probability distribution shown in FIG. 2;

FIG. 9 shows another example of the profile information input screen when the user input is completed;

FIG. 10 shows another modified example of the probability distribution shown in FIG. 2;

FIG. 11 shows a flowchart illustrating a recommendation operation of the recommendation apparatus;

FIG. 12 shows an example of the probability distribution;

FIG. 13 shows examples of a recommendation displaying screen;

FIG. 14 shows another example of the recommendation displaying screen;

FIG. 15 shows another example of the recommendation displaying screen; and

FIG. 16 shows a probability distribution when a rule for exclusion from recommendation candidates is changed from a rule used in FIG. 12.

### DESCRIPTION OF THE EMBODIMENTS

An illustrative embodiment of this invention will be described below with reference to the drawings.

<1. Configuration of Content Offering System>

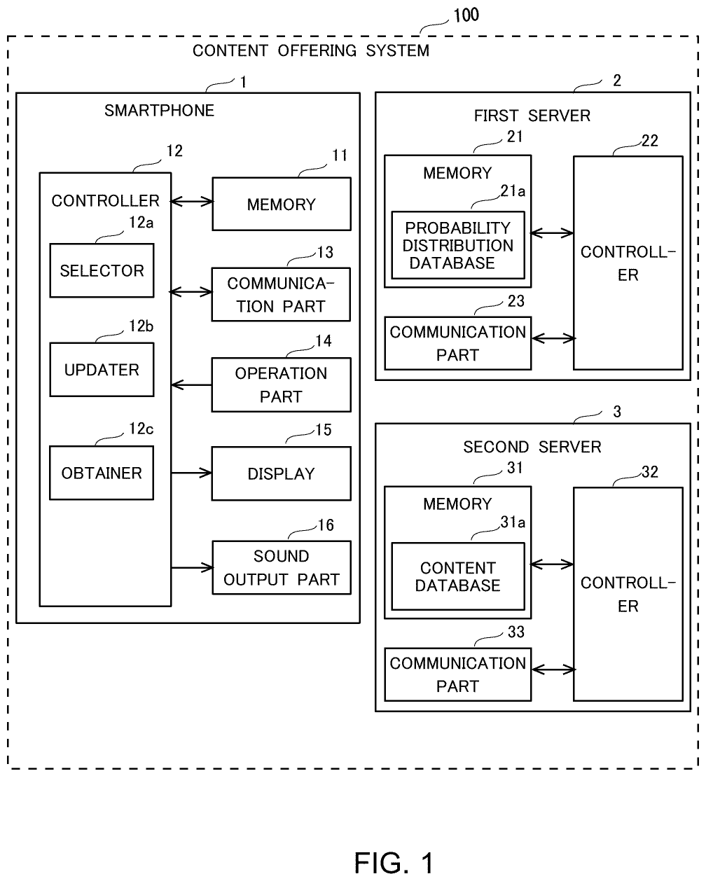

FIG. 1 shows an example of a schematic configuration of a content offering system of this embodiment. The content offering system 100 includes a smartphone 1, a first server 2, and a second server 3.

The smartphone 1 is an example of a recommendation apparatus that recommends a content to a user. The recommendation apparatus may be an electric device other than a smartphone. In this embodiment, the smartphone 1 recommends the user music. However, music is only an example of the content and the content to be recommended is not limited to music. In addition to the music, a movie, an article on a web site/a magazine, and a cartoon, the content to be recommended may be a destination, a store/restaurant, a route to a destination, a store, and a restaurant, and the like that relates to a preference, a habit, a custom, etc. of the user.

Moreover, the smartphone 1 is also an example of a content request apparatus. When the user has accepted the content recommended by the recommendation apparatus, the content request apparatus requests the accepted content. In this embodiment, one electronic device functions as both the recommendation apparatus and the content request apparatus. However, the recommendation apparatus and the content request apparatus may be different electronic devices.

The first server 2 provides an initial setting of a probability distribution to the smartphone 1. Details of the initial setting of the probability distribution will be described later.

The second server 3 is an example of a content providing apparatus. The content providing apparatus provides the content in response to a request from the content request apparatus.

<2. Configuration of Smartphone>

The smartphone 1 includes a memory 11, a controller 12, a communication part 13, an operation part 14, a display 15, and a sound output part 16.

The memory 11 stores system software, application software, data, etc.

The system software is read out and executed by the controller 12 to control the smartphone 1.

When the application software for the recommendation apparatus is read out and executed by the controller 12, the smartphone 1 functions as the recommendation apparatus. When the application software for the content request apparatus is read out and executed by the controller 12, the smartphone 1 functions as the content request apparatus. The application software for the recommendation apparatus and the application software for the content request apparatus may be one integrated application software or may be different application software from each other.

The memory 11 stores, as one of the data, the probability distribution of a probability of a likelihood of matching a preference of the user. The memory 11 stores the probability distribution across a plurality of content genres (term “content genre” means a genre to which a content belongs and is hereinafter referred to also simply as “genre”) of the content. The probability distribution is stored, for example, in a form of data table in the memory 11.

The controller 12 is a computer that includes at least one processor. More specifically, the controller 12 is the computer that includes a central processing unit (CPU), a random access memory (RAM), and/or a read only memory (ROM), not illustrated. The controller 12 processes and communicates information based on a program stored in the memory 11, and controls the entire smartphone 1.

The controller 12 includes a selector 12a, an updater 12b, and an obtainer 12c. Each function of the controller 12, such as the selector 12a, is performed by the CPU executing arithmetic processing according to the application software for the recommendation apparatus stored in the memory 11.

The selector 12a selects the content to be recommended to the user based on the probability distribution stored in the memory 11.

The updater 12b updates the probability distribution by learning from a feedback about acceptance or nonacceptance by the user of the recommended content. For example, a Bayesian network and the like may be used as a learning algorithm. The learning algorithm is not limited to Bayesian networks.

The obtainer 12c obtains profile information of the user. More specifically, the obtainer 12c obtains the profile information of the user that is input to the smartphone 1 by a user operation with the operation part 14.

The communication part 13 wirelessly communicates with a communication part 23 of the first server 2 and a communication part 33 of the second server 3 by a network, not illustrated.

Moreover, the communication part 13 may communicate with another electric device located in a vicinity of the smartphone 1 by near field communication or wired communication. For example, when the smartphone 1 is used in a cabin of a vehicle, the communication part 13 of the smartphone 1 may communicate with an apparatus, a device, a unit, etc. fixed in the vehicle by near field communication or wired communication.

The operation part 14 receives the user operation and outputs an operation signal according to the user operation to the controller 12. Examples of the operation part 14 are a touch panel, a hard switch, etc.

The display 15 displays a content, information, an image, etc. in response to control of the controller 12. Examples of the display 15 are an organic electro luminescence (EL) display, a liquid crystal display, etc.

The sound output part 16 outputs sound in response to control of the controller 12. Examples of the sound output part 16 is a speaker and the like.

When the communication part 13 communicates with the electric device located in the vicinity of the smartphone 1 by near field communication or wired communication, an operation part, a display, and a sound output part of the electronic device may work with the smartphone 1, instead of or in addition to the operation part 14, the display 15, and the sound output part 16.

<3. Configurations of First Server and Second Server>

The first server 2 includes a memory 21, a controller 22, and the communication part 23.

The controller 22 is a computer that includes at least one processor. More specifically, the controller 22 is the computer that includes a CPU, a RAM, and/or a ROM, not illustrated. The controller 22 processes and communicates information based on a program stored in the memory 21, and controls the entire first server 2.

The memory 21 includes probability distribution database 21a. The probability distribution database 21a stores probability distributions of probabilities of a likelihood of matching preferences of users. The probability distribution database 21a stores the probability distributions across the plurality of content genres of the contents for each typical profile type of the users. The probability distributions are stored, for example, in a form of data table in the probability distribution database 21a.

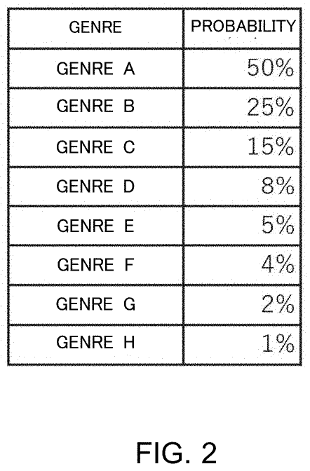

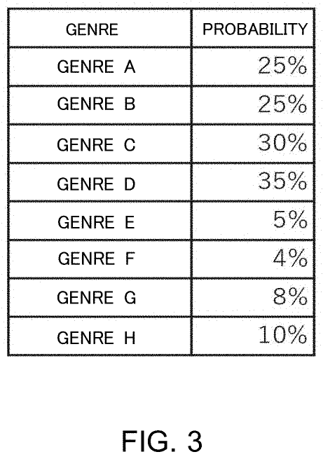

FIG. 2 shows an example of a probability distribution for a user who is male in his thirties (thereinafter referred to as “30s”). FIG. 3 shows an example of a probability distribution for a user who is female in her twenties (hereinafter referred to as “20s”). The probability distribution database 21a stores the probability distribution shown in FIG. 2, the probability distribution shown in FIG. 3, and other probability distributions, for example, a probability distribution for a user who is male in his fifties. The probability distributions stored in the probability distribution database 21a are created based on results of questionnaires that have been filled out in advance by a plurality of individuals per typical profile type of the users. Here, the plurality of individuals may be non-users and/or may be a portion of or all the users. A probability distribution database may be arbitrarily created in advance based on data without questionnaires.

The communication part 23 wirelessly communicates with the communication part 13 of the smartphone 1 by the network, not illustrated.

The second server 3 includes a memory 31, a controller 32, and a communication part 33.

The controller 32 is a computer that includes at least one processor. More specifically, the controller 32 is the computer that includes a CPU, a RAM, and/or a ROM, not illustrated. The controller 32 processes and communicates information based on a program stored in the memory 31, and controls the entire second server 3.

The memory 31 includes a content database 31a. The content database 31a stores a plurality of music. In the content database 31a, sound data of each music is associated with information, such as, music title, singer, and genre. In an explanation below, music in a genre A is referred to as “music An” (“n” is an Arabic numeral). Music in any of genres B to G is referred in a same manner. For example, music in the genre G is referred to as “music Gn (“n” is an Arabic numeral).”

The communication part 33 wirelessly communicates with the communication part 13 of the smartphone 1 by the network, not illustrated.

<4. Initial Operation of Recommendation Apparatus>

Next described is an initial operation of the recommendation apparatus. When the application software for the recommendation apparatus is activated in the smartphone 1 for a first time, the initial operation of the recommendation apparatus is executed. For example, the initial operation of the recommendation apparatus is executed on a date on which this application is filed.

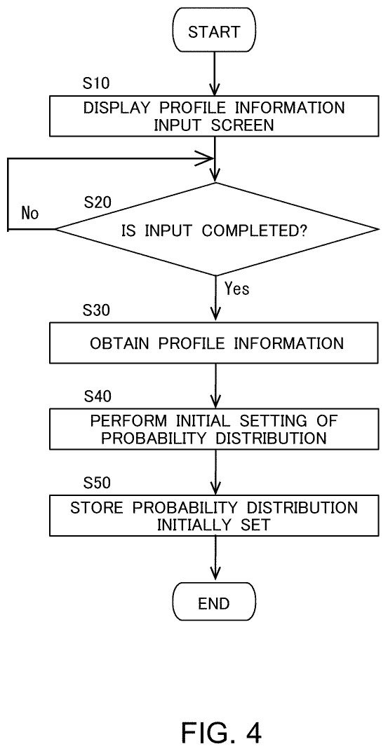

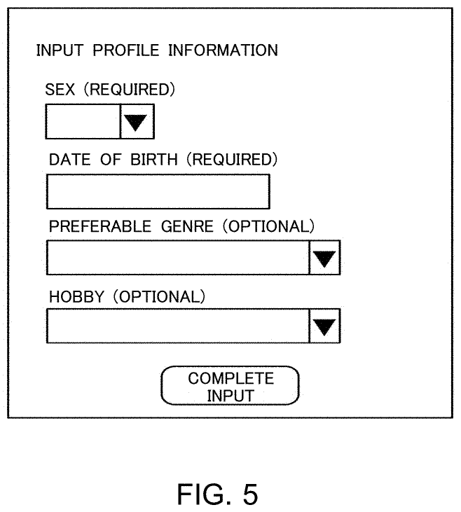

FIG. 4 shows a flowchart illustrating the initial operation of the recommendation apparatus. When the flowchart shown in FIG. 4 is started, first, the display 15 displays a profile information input screen, as shown in FIG. 5, for the user to input profile information (a step S10).

In an example of the profile information input screen shown in FIG. 5, items of sex and date of birth are items required to be input, and items of preferable genre and hobby are optional items to be input. Moreover, in the example of the profile information input screen shown in FIG. 5, the user chooses one from a pull-down menu for each of the items sex, preferable genre and hobby, and the user cannot freely write.

When the user touches an area of the touch panel corresponding to a “complete input” button on the profile information input screen shown in FIG. 5, a user input is completed. When the user touches the area of the touch panel corresponding to the “complete input” button on the profile information input screen shown in FIG. 5 without inputting information in any of the required items, the display 15 may display an error message.

The controller 12 determines whether or not the user input on the profile information input screen is completed (a step S20).

When the user input on the profile information input screen is completed, the obtainer 12c of the controller 12 obtains the entered profile information (a step S30), and then the controller 12 performs the initial setting of the probability distribution (a step S40). Then the memory 11 stores the probability distribution that has been initially set by the controller 12 (a step S50). When the step S50 ends, the flowchart shown in FIG. 4 ends.

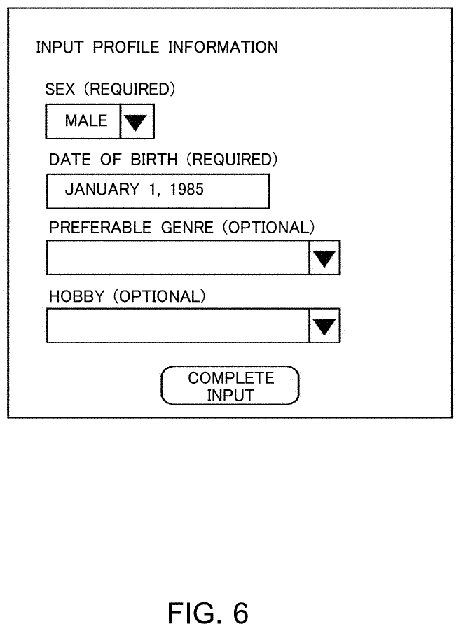

For example, as shown in FIG. 6, when the user input is completed with male in the item sex, Jan. 1, 1985 in the item date of birth, and no information in the optional items on the profile information input screen, the controller 12 requests, via the communication part 13, the first server 2 to send the probability distribution for male in his 30s shown in FIG. 2. In response to the request, the first server 2 sends, to the smartphone 1, the probability distribution for male in his 30s shown in FIG. 2. The controller 12 uses the probability distribution for male in his 30s shown in FIG. 2 as the initial setting of the probability distribution. Moreover, if a plurality of initial probability distributions are stored in advance in an internal memory area of the smartphone 1, the controller 12 may read out the initial probability distribution data from the internal storage area of the smartphone 1 without receiving the probability distribution data sent from the first server 2.

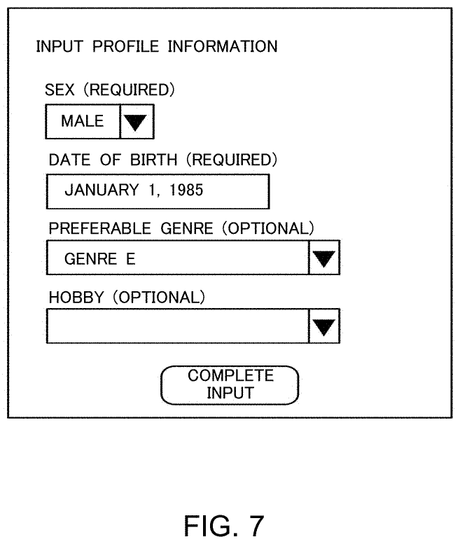

Moreover, for example, as shown in FIG. 7, when the user input is completed with male in the item sex, Jan. 1, 1985 in the item date of birth, and genre E in the item preferable genre on the profile information input screen, the controller 12 requests, via the communication part 13, the first server 2 to send the probability distribution for male in his 30s shown in FIG. 2. The first server 2 sends, to the smartphone 1, the probability distribution for male in his 30s shown in FIG. 2 in response to the request. The controller 12 modifies the probability distribution for male in his 30s shown in FIG. 2, and uses the modified probability distribution as the initial setting for the user.

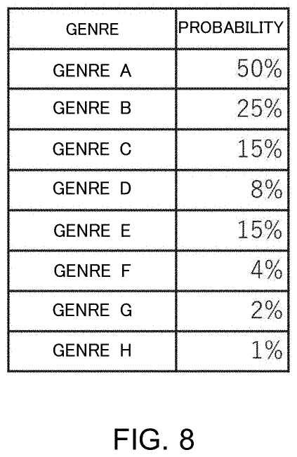

A manner has been determined in advance in which the probability distribution reflects an input entered in the item preferable genre. The determined manner is stored in the memory 11. For example, in a case where it has been determined to increase by 10% a probability of an preferable genre entered in the profile information, the controller 12 modifies the probability distribution for male in his 30s shown in FIG. 2 to a probability distribution shown in FIG. 8, and uses the modified probability distribution as the initial setting for the user who is male in his 30s.

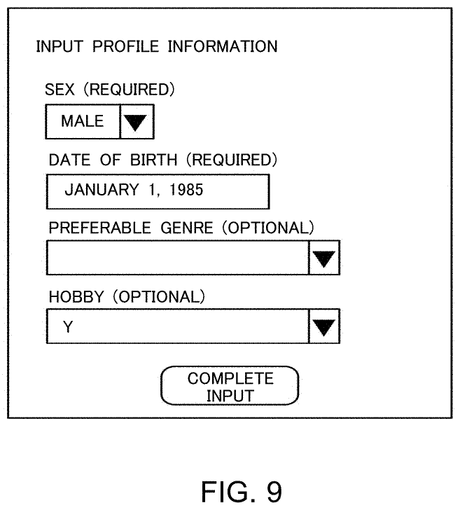

Moreover, as shown in FIG. 9, when the user input is completed with male in the item sex, Jan. 1, 1985 in the item date of birth, and Y in the item hobby on the profile information input screen, the controller 12 requests, via the communication part 13, the first server 2 to send the probability distribution for male in his 30s shown in FIG. 2. The first server 2 sends, to the smartphone 1, the probability distribution for the user who is male in his 30s shown in FIG. 2 in response to the request. The controller 12 modifies the probability distribution for male in his 30s shown in FIG. 2, and uses the modified probability distribution as the initial setting for the user who is male in his 30s.

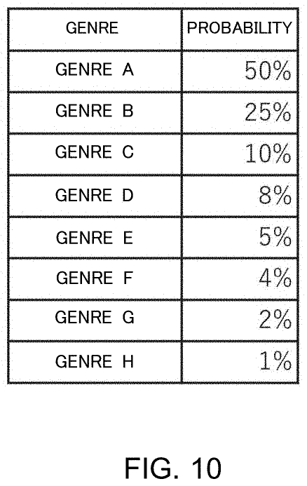

A manner has been determined in advance in which the probability distribution reflects an input entered in the item, such as hobby, that indirectly affects the probability. The determined manner is stored in the memory 11. For example, in a case where it has been determined to increase a probability of the genre A by 3% when a hobby of the user is X and to decrease a probability of the genre C by 5% when a hobby of the user is Y, the controller 12 modifies the probability distribution for male in his 30s shown in FIG. 2 to a probability distribution shown in FIG. 10, and uses the modified probability distribution as the initial setting for the user.

In other words, the smartphone 1 has a first feature that an initial input entered by the user is reflected into the initial setting of the probability distribution. Thus, it is possible to reduce an unsuitable recommendation in an early stage of learning. Moreover, since such an unsuitable recommendation is reduced in the early stage of the learning, it is possible to facilitate the learning. Thus, user satisfaction can be improved.

In this embodiment, modification of the probability distribution is performed by the smartphone 1 according to the user input entered in the optional item. However, the smartphone 1 may send information of the user input entered in the optional item to the first server 2, and the modification may be performed by the first server 2, and then the modified probability distribution may be sent to the smartphone 1 from the first server 2.

<5. Recommendation Operation of Recommendation Apparatus>

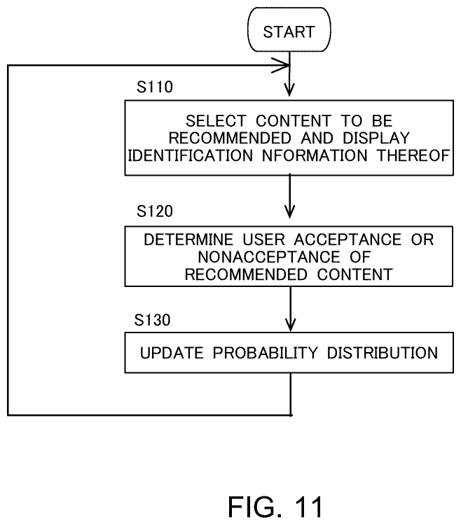

Next described will be a recommendation operation that is performed by the recommendation apparatus. When the initial operation described above is completed, the recommendation operation that is performed by the recommendation apparatus is available. FIG. 11 shows a flowchart illustrating the recommendation operation that is performed by the recommendation apparatus.

The selector 12a of the controller 12 selects the content to be recommended to the user based on the probability distribution stored in the memory 11. The display 15 displays identification information such as a title of the content selected by the selector 12a (hereinafter “content title” is used as an example to be displayed) (a step S110). The selector 12a of the controller 12 may select a content to be recommended to the user based on the probability distribution stored in the memory 11 and a use situation of the recommendation apparatus. The use situation of the recommendation apparatus may include, for example, time of a day, day of the week, place, weather, etc. When the recommendation apparatus is used in the cabin of the vehicle, the use situation may include presence/absence of another occupant, presence/absence of a child as an occupant, etc.

In a step S120 following the step S110, the updater 12b of the controller 12 determines whether or not the recommendation (recommended content) has been accepted. In other words, the updater 12b of the controller 12 determines whether or not the content (music) selected by the selector 12a has been selected and played.

Then, the updater 12b of the controller 12 updates the probability distribution by learning from a feedback about acceptance or nonacceptance by the user of the recommended content (a step S130). The updated probability distribution is stored in the memory 11 in a same manner as the probability distribution stored before the update.

When the step S130 ends, the flow returns to the step S110. The steps of the flowchart shown in FIG. 11 are repeated until the application software for the recommendation apparatus is ended.

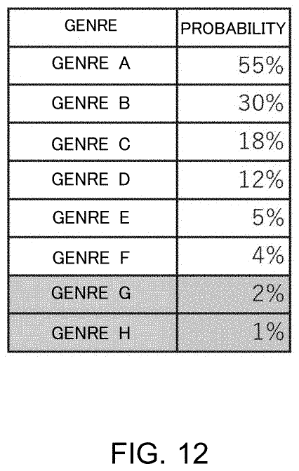

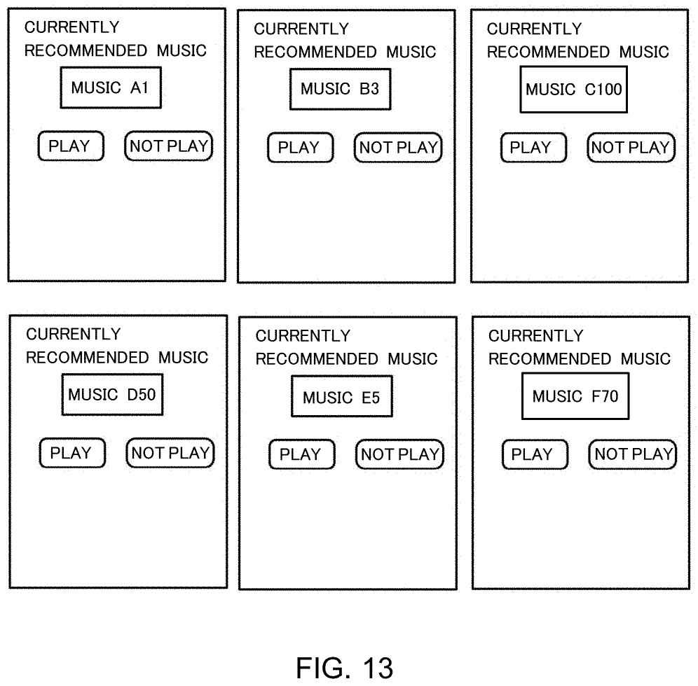

In this embodiment, the selector 12a excludes, from recommendation candidates (contents to be displayed as choices), a content in a genre for which a probability is equal to or smaller than a predetermined value. For example, in a case where the selector 12a selects the content to be displayed based on the probability distribution, as shown in FIG. 12, stored in the memory 11 in the step S110 and the predetermined value is 3% (this case is hereinafter referred to as “first case”), contents in the genre G and the genre H are not recommended to the user. In other words, in the first case, the selector 12a can select contents from genres A to F as the contents to be recommended, depending on an algorithm of the learning. In the step S110, the recommended contents are displayed as shown in FIG. 13. In a display example shown in FIG. 13, the display 15 displays content titles, for example, from “Music A1,” “Music B3,” “Music C100,” “Music D50,” “Music E5,” and then “Music F70” in order. “Play” or “Not play” is selected by the user operation for each of the music. The music selected with “Play” is played in order. Alternatively, the recommendation apparatus may perform a processing below. In the display example shown in FIG. 13, for example, the display 15 displays the content tile “Music A1.” While the content title “Music A1” is being displayed, when “Play” is selected by the user operation, the “Music A1” is played, and when “Not play” is selected by the user operation, the display 15 displays the content title “Music B3.” Then, while the content title “Music B3” is being displayed, when “Play” is selected by the user operation, the “Music B3” is played, and when “Not play” is selected by the user operation, the display 15 displays the content title “Music C100.” When “Not play” is continuously selected by the user operation, the display 15 lastly displays the content title “Music F70.” A display order of the display example shown in FIG. 13 is only an example, and another display order may be used.

In this embodiment, the smartphone 1 has a second feature that excludes, from the recommendation candidates, the content in the genre for which the probability is equal to or smaller than the predetermined value. Thus, an unsuitable recommendation can be reduced. Since the unsuitable recommendation is reduced, it is possible to facilitate the learning. Thus, user satisfaction can be improved.

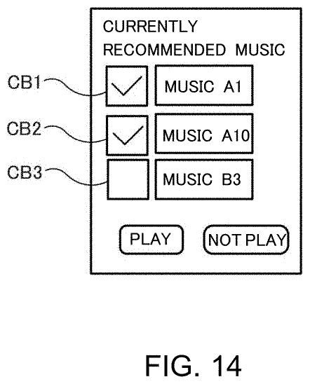

Moreover, in this embodiment, the selector 12a selects a plurality of the contents to be recommended, and the display 15 simultaneously displays titles of the plurality of contents selected by the selector 12a. In other words, the smartphone 1 has a third feature that the plurality of contents are selected to be recommended, and identification information of the plurality of contents are simultaneously displayed. For example, in the first case, the selector 12a selects three contents to be recommended from amongst the genres A to F. In other words, in the step S110, the titles of the contents to be recommended can be simultaneously displayed as shown by a recommendation displaying screen in FIG. 14. Thus, acceptance or nonacceptance of the plurality of contents can be decided by the user simultaneously. Accordingly, the learning can be facilitated. Moreover, since the plurality of contents are recommended, it is more likely to be selected by the user as music to be played. Thus, user satisfaction can be improved. A format in which the identification information of the plurality of contents is simultaneously displayed is not limited to an example shown in FIG. 14. When an area to display the identification information of the plurality of contents needs more than one screen, a display screen may be moved to a previous screen or a next screen by a scroll or a page feed operation. In other words, the simultaneous display described above means a display format in which a portion of or all the content titles of the plurality of contents selected by the selector 12a can be selected in a batch by the user operation with the operation part 14. A display order of the content titles of the plurality of contents selected by the selector 12a may be in descending order of probabilities of those contents. In an example shown in FIG. 14, a probability of the content title “Music F70” is highest followed by the content title “Music C5.” A probability of the content title “Music E5” is lowest among these three contents. However, giving priority to display a content title having a low probability may be effective in offering a fresh content recommendation to the user with a certain frequency so that the content titles may be displayed in order according to the probabilities of the content titles. For example, a content title of a content having a 10% probability may be displayed with a highest priority (at a top area of the display screen) once in ten times. Moreover, for example, the highest priority (displaying at the top area of the display screen) is always given to a content tile of a content having a highest probability and a content title to be displayed with a second highest priority may be changed in accordance with the probabilities of the contents. The content titles of the plurality of contents selected by the selector 12a may be displayed at random.

On the recommendation displaying screen shown in FIG. 14, when a checkbox CB1 is checked by the user operation with the operation part 14, the content title “Music A1” is a playback target. When a checkbox CB2 is checked by the user operation with the operation part 14, the content title “Music A10” is a playback target, and when a checkbox CB3 is checked by the user operation with the operation part 14, the content title “Music B3” is a playback target. When the user touches an area corresponding to a play button on the recommendation displaying screen, as shown in FIG. 14, having the checkboxes CB1 and CB2 checked, the content titles “Music A1” and “Music A10” are played in order.

The selector 12a selects the contents only from the genres having the high probabilities (that means genres for which the probabilities are high) for the recommendation displaying screen shown in FIG. 14. However, if a content is always recommended from a genre having a high probability and a content is not recommended from a genre having a low probability, the learning is not facilitated. Moreover, if a content is always recommended from the genre having the high probability, similar contents are continuously recommended and such a recommendation may lead to dissatisfaction of the user.

Therefore, it is preferable that a probability range should be divided into a plurality of groups and the selector 12a should select the contents to be recommended from at least two groups. Thus, the probability may change easily in accordance with acceptance or nonacceptance by the user of the recommended contents. Thus, the learning is facilitated. In addition, continuous recommendations of similar contents can be suppressed so that user satisfaction is improved.

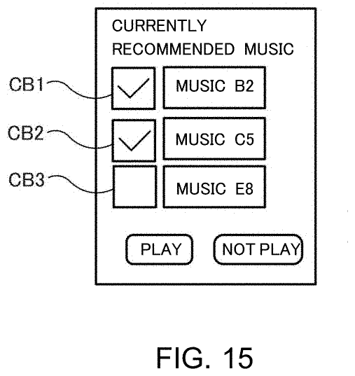

For example, the selector 12a divides the probability range into four groups of a high probability group (probability of 30% or higher), a middle probability group (probability from 10% to less than 30%), a low probability group (probability of higher than 3% to less than 10%), and an out-of-recommendation group (3% or lower). The selector 12a selects one content each from the high, middle and low probability groups. For example, when the selector 12a selects one content each from the high, middle, and low probability groups in the first case, the display 15 displays the recommendation displaying screen, for example, as shown in FIG. 15. The selector 12a may select more contents from a group having a highest probability than contents from the other groups, instead of selecting same number of contents from those groups. Accordingly, the selector 12a can recommend more contents that are more likely to match the preference of the user. For example, the selector 12a may select three contents from the high probability group, and two from the middle probability group, and one from the low probability group. Moreover, for example, the selector 12a may select two contents from the high probability group, and one each from the middle and low probability groups.

In this embodiment, the smartphone 1 has a fourth feature that a rule to select the content to be recommended changes in accordance with a progress of the learning. Thus, the user more easily understands the progress of the learning and user satisfaction is improved.

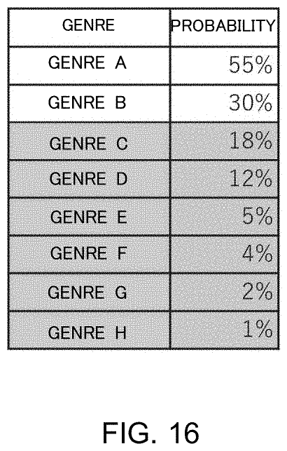

For example, when the progress of the learning reaches a predetermined level, the selector 12a changes the predetermined value from 3% to 20% (refer to FIG. 16). The progress of the learning may be defined as a rate that the contents recommended in a predetermined span have been accepted by the user. The predetermined span may be one hour, one day, one week, or number of recommendations.

The change of the rule to select a content to be recommended is not limited to the predetermined number described above. For example, when the progress of the learning is low, one content may be selected from each of the high, middle, and low probability groups. When the learning has progressed, three contents may be selected from the high probability group or two contents and one content may be selected from the high probability group and the middle probability group, respectively. In other words, as the learning progresses, reliability of the probability distribution increases. Thus, since more contents matching the preference of the user are displayed, recommending more contents selected from the higher probability group(s) is more effective and realistic to display choices.

Moreover, in the foregoing example, the progress of the learning is grouped into two levels of an under-predetermined level and a predetermined or higher level. However, number of the levels is not limited to two, and may be three or more.

<6. Modifications>

The foregoing embodiment shows an example in every aspect and does not intend to limit the invention. A technical scope of the invention is defined not by the foregoing embodiment but by the scope of claims. It should be understood to include all changes and modifications that fall within a scope of the claims and meanings and scopes of equivalents of the claims.

For example, the smartphone 1 may periodically send a set of the profile information and the probability distribution to the first server 2. The first server 2 may use the obtained set of the profile information and the probability distribution, for example, to modify the probability distribution database 21a.

In the manner in which the smartphone 1 sends the set of the profile information and the probability distribution to the first server 2, personal information, such as acceptance/nonacceptance by each user about the recommended contents, is not sent to the first server 2 from the smartphone 1, and only rough profile information is sent to the first server 2. Thus, as compared to a manner in which the smartphone 1 sends the personal information to the first server 2, the manner of this embodiment is better in terms of personal information protection.

In the foregoing embodiment, the smartphone 1 includes all the first to fourth features. However, the recommendation apparatus may include at least one of the first to fourth features. In other words, each of the first to fourth features is possible to be performed alone.

While the invention has been shown and described in detail, the foregoing description is in all aspects illustrative and not restrictive. It is therefore understood that numerous other modifications and variations can be devised without departing from the scope of the invention.

What is claimed is:

1. A recommendation apparatus that recommends content to a user, the apparatus comprising:
a memory that stores a probability distribution of a probability of a likelihood of matching a preference of the user, the probability distribution being across a plurality of content genres of the content; and
a hardware processor programmed to:
(i) select a content to be recommended to the user based on the probability distribution,
(ii) update the probability distribution by learning from a feedback about acceptance or nonacceptance by the user of the content that was recommended, and
(iii) obtain profile information of the user, the profile information of the user being reflected in an initial setting of the probability distribution.

2. The recommendation apparatus according to claim 1, wherein
the hardware processor excludes, from being recommendation candidates, the content in the content genre for which the probability is equal to or smaller than a predetermined value.

3. The recommendation apparatus according to claim 1, wherein
the hardware processor selects a plurality of the contents to be recommended to the user.

4. The recommendation apparatus according to claim 3, wherein
a probability range is divided into a plurality of groups, and the hardware processor selects the plurality of contents to be recommended from at least two of the plurality of groups.

5. The recommendation apparatus according to claim 1, wherein
the hardware processor changes a rule to select the content to be recommended in accordance with a progress of the learning.

6. A content offering system comprising:
a recommendation apparatus that recommends content to a user, the recommendation apparatus including:
a memory that stores a probability distribution of a probability of a likelihood of matching a preference of the user, the probability distribution being across a plurality of content genres of the content; and
a hardware processor programmed to:
(i) select a content to be recommended to the user based on the probability distribution,
(ii) update the probability distribution by learning from a feedback about acceptance or nonacceptance by the user of the content that was recommended, and
(iii) obtain profile information of the user, the profile information of the user being reflected in an initial setting of the probability distribution;
the hardware processor, when the content that was recommended has been accepted by the user, making a request for the accepted content; and
a content providing server that provides the content in response to the request from the hardware processor.

7. A recommendation method of recommending content to a user, the method comprising the steps of:
(a) storing, in a memory, a probability distribution of a probability of a likelihood of matching a preference of the user, the probability distribution being across a plurality of content genres of the content;
(b) selecting, by a hardware processor, a content to be recommended to the user based on the probability distribution;
(c) updating, by the hardware processor, the probability distribution by learning from a feedback about acceptance or nonacceptance by the user of the content that was recommended; and
(d) obtaining, by the hardware processor, profile information of the user, the profile information of the user being reflected in an initial setting of the probability distribution.
